(19) United States
(12) Patent Application Publication
(10) Pub. No.: US 2011/0265018 A1
(43) Pub. Date: Oct. 27, 2011

(54) EMOTION AND MOOD CONTROL OF VIRTUAL CHARACTERS IN A VIRTUAL WORLD

(75) Inventors: Karl Joseph Borst, Toronto (CA); John Alexander Larsen, Toronto (CA); Joseph Benjamin Ganetakos, Toronto (CA)

(73) Assignee: GANZ, Woodbridge (CA)

(21) Appl. No.: 13/091,916

(22) Filed: Apr. 21, 2011

Related U.S. Application Data
(60) Provisional application No. 61/327,364, filed on Apr. 23, 2010.

(51) Int. Cl. G06F 3/048

(52) U.S. Cl. 715/757

(57) ABSTRACT

A virtual world in which users can be represented by avatars that can communicate with both other avatars and with non-player characters (NPC's). During the communication, entering of an emotional text language causes the avatar itself to be animated to show emotion.

This application claims priority from provisional application No. 61/327,364, filed Apr. 23, 2010, the entire contents of which are herewith incorporated by reference.

### BACKGROUND

U.S. Pat. No. 7,425,169, filed Dec. 30, 2004 describes a system of interacting with a virtual representation of a real world product. According to this system, a user can buy a toy such as 100 which is associated with a special code. The toy 100 exists in the real world, and the code forms a key to the virtual world 110. The user enters the code 105 on a website and enters the virtual world 110.

The virtual world 110 provides activities and views with which the user can interact. The virtual world, as part of the interaction, provides a virtual replica 115 of the actual toy 100. Users can carry out various activities on the website using their virtual version of the toy. For example, the user can form a house with rooms, furniture, clothing, and other items. The user can also carry out activities to earn cash, and purchase virtual items using that cash.

### SUMMARY

A method according to one aspect includes representing a user by an avatar in a virtual world on a computer; communicating, from the user to another user in the virtual world, where said communicating shows a picture of the user's avatar during the communicating; said communicating including receiving entered typed text forming a message from the user, where said entered typed text are transmitted to be shown to said another user as words, characters or both words and characters; determining if said entered typed text typed by the user includes an indication of an emotion as part of said entered typed text, said indication of said emotion being formed by text characters entered as part of said communicating and where said indication of said emotion includes characters typed as part of said message from said user and said characters do not form a word in a language of the message; and representing said emotion represented by said characters by animating said avatar show shown as part of said communicating to show said emotion while providing said message to said another user as part of said communicating.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 shows an illustrative embodiment of a flow operation in which free and paid users can sign up for an account;

FIG. 2 shows an illustrative example of the expansion of a village from a central base village to include different elements added by different players;

FIG. 3 shows an illustrative example of interactions between different maps;

FIG. 4 illustrates how initially, at times, when user's avatars talk, others perceive an accent in their speech, and said accent can fade over time;

FIG. 5 shows an illustrative embodiment of a messaging service including a virtual image of an avatar's face, as well as a cartoonish speech bubble for reproducing text characters when the avatar speaks;

FIG. 6 shows an illustrative embodiment of the operation of a karma system;

FIG. 7 shows an illustrative relationship of the sync server to other server clusters in Tail Towns™; and

FIG. 8 shows an illustrative embodiment of arrangement of communication paths among Tail Towns™ servers.

### DETAILED DESCRIPTION

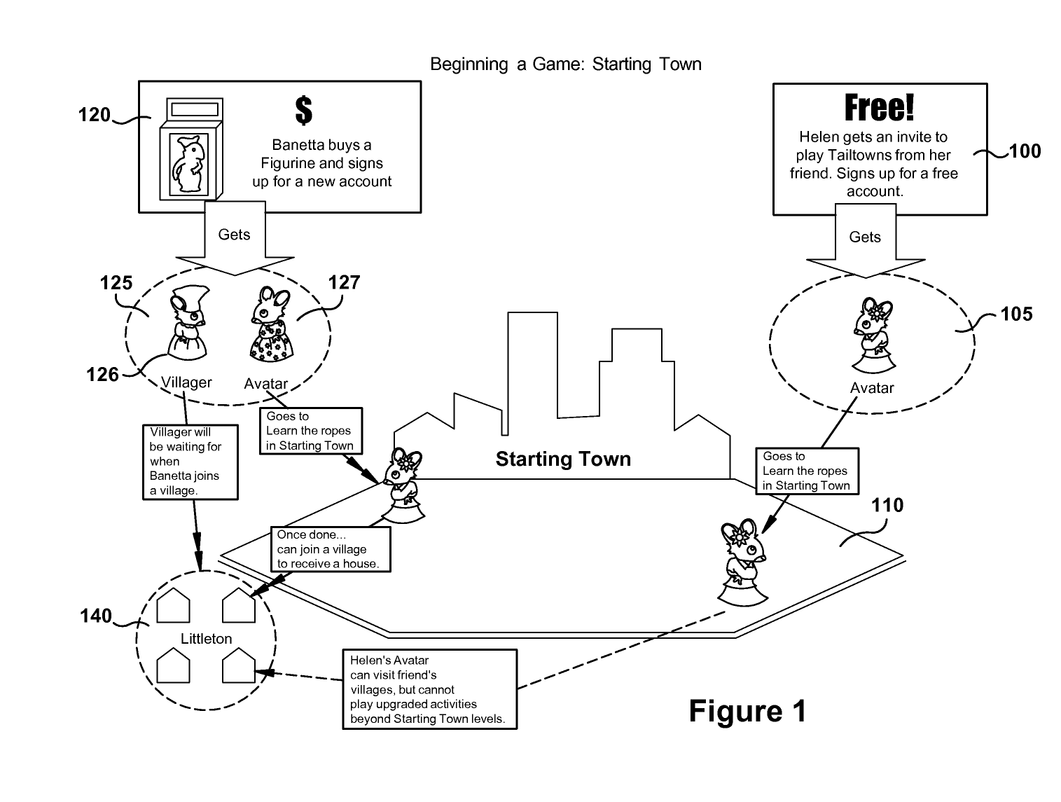

The present application describes additional aspects, actions and activities and additional structure, for adding to a website of the type described in U.S. Pat. No. 7,425,169, and as shown generally in FIG. 1. It should be understood, however, that the aspects described herein are not limited to use with the system described with reference to FIG. 1. These aspects can be used with other kinds of websites and/or games; for example, any website that allows user interaction can be used with this system. An embodiment describes new operations using the website illustrated in FIG. 1.

According to a first embodiment, a special world called Tail Towns™ is used within the virtual environment, a world where civilized group of mice have started their own tentative steps into a wider world mirroring the Victorian age of exploration that occurred in the ‘real’ world.

Within the virtual world, there can be different kinds of characters in the game, that are controlled by players/users who area playing the game. There are also virtual places within the game, specifically, described below:

Avatar: A customizable player-controlled character that is used to directly play the game. This avatar is given to all accounts (Free or Paid) and forms the main method of interacting with the game.

Figurines: These are the toys that act as a subscription to the Paid services of our game. With a purchased figurine, a player will be allowed to own a villager based on the purchased figurine.

Virtual Figurines: Instead of purchasing an actual toy figurine, a player may instead wish to purchase a virtual figurine, which is simply a way of paying for the privilege of unlocking a certain type of villager.

Villagers: Characters based on the bought figurines. The term ‘villager’ refers to a character that is not directly controlled by a player, but belongs to a player and lives within a player's village.

These characters are mainly controlled by an artificial intelligence (“AI”) engine, but may also have extra interactivity with the player.

NPC's: These non-player characters (NPC's) are not owned or played with by any of the players. These characters are fully controlled by the AI engine. Notable examples of NPC's include postal officers and merchants. These will be a part of any starting village, the moment it is formed.

Murinia: The motherland of the civilized mice. A large peaceful island (with no cats of any sort), where all players start playing the game. If compared to our own colonial history, Murinia is like Great Britain, while the villages are like the colonies of the New World.

Crosston: The capital of Murinia. The starting town for the players of Tail Towns™. Using the same historical comparison as above, Crosston is the equivalent to London, a great hub of trading between all of the colonies.

$queaks: The virtual currency of the Tail Towns™ virtual world.

Karma: In Tail Towns™, karma is a very light-hearted take on the spiritual concept of action and reaction. Embodiments describe two flavors of karma: naughty karma and nice karma. Naughty karma implies the user is playing lighthearted tricks on other players. In fact, naughty karma is a type of reward. Karma will be a hidden attribute, in which there is no visible indicator of what a player's karma actually is. The player will need to discover and figure out the karmic relationships and modifies through experimentation, or discussion with other players.

Crafts: Crafts are items that can only be found by either playing a game to make the item, or by combining items to match an established recipe. Crafts are basically items that are primarily generated by an interactive activity of some sort.

Mini-Games: Applies to all games within the greater ‘game’ of Tail Towns™. Mini-games might be puzzle, action, card, strategy, or time management games of a casual nature fitted into the larger structure of the massively multiplayer online (“MMO”) style of the main ‘game’ of Tail Towns™. These games can be either single-player, multiplayer co-operative, or multiplayer competitive. Quests are also contained within the greater ‘Mini-Game’ category as they will often blend a number of mini-game types with the MMO experience.

Levels: Villagers are the only characters with numerical levels. Leveling a villager is simply done by purchasing another figurine of the same villager type. (i.e. a pizza cook figurine levels up the user's cook villager). Levels bring new enhancements to what the player and/or village can experience and do.

Ranking: This is a primary way to show how an avatar is progressing. Players can improve their avatar's ranking by the number of skill badges gathered.

Quests: This is a method of gameplay that players can engage in, directly with their personal avatar. These quests are a succession of tasks that need to be accomplished, but unlike traditional fantasy MMO's, these quests are designed to either mimic or facilitate (or both) social interactions between the characters in the game.

Events: System wide activities that affect an entire area, such as a whole village or Crosston. Events may temporarily unlock certain mini-games or styles of mini-games, or may offer unique quests to engage in. Often events have a visual theme that will temporarily alter the look of an area for the duration of the event.

Players come to (i.e., gain access to) Tail Towns™ through either the free option or by purchasing a Figurine. Both options give the players a customizable avatar that uniquely represents the player in the world of Tail Towns™. Both types of players have essentially the same experience at first. Both start the game in the starting town area, where the players get a small apartment and learn how to play the game. However, a player who purchased a Figurine gets the option of moving out of Murinia and into his/her own village (most likely with a group of other players).

Each figurine bought includes a code that unlocks a villager of that same type and represents the key to the wider world of Tail Towns™. Players, who sign up for the free account, are limited to living in Murinia. These players may visit other villages if invited or on special market days, holidays or festivals.

FIG. 1 illustrates the flow operation in which a free user at 100 can sign up for a free account 100, and can receive an avatar 105 which can be used within the starting town 110. In a parallel path, a paid user 120 buys the figurine and signs up for a new account. The paid user gets both a villager 126 and an avatar 127 at 125. The avatar 127 goes into the starting town 110 to learn the ropes. The villager 126 goes into the final town 140 and waits for the avatar 127 to arrive. Once the villager (via its avatar 127) has learned the ropes, the villager arrives in the town 140.

Great emphasis is placed on collecting, in the world of Tail Towns™. Whether it is personal items to dress and decorate the avatar 127, items to put in a home for the avatar 127, a large group of friends or a large village with every possible villager and building type, there are many possibilities for the avid collector to focus on. Players can primarily decorate their personal Avatar, as well as their home (interior and exterior). Players can influence circumstances that indirectly influence the decoration of a town (permanently and temporarily).

For avatar and home decorating, the player needs to win, find, receive or purchase adornments in the game, and apply the items, whether to person or to home. For village decorating, the player will usually do much more. Purchasing or unlocking an exterior skin for any of the village buildings (including the home) will help to give the village a new look. Unlocking or winning enhancements to events will also provide temporary decorations (i.e. holiday themes). Obtaining new villagers that include buildings will also change the look of a town, as will certain villagers, such as gardeners, that will introduce new foliage to what can exist within a town. Visiting other towns can help carry seeds, thus changing the types of flowers and plants that grow wildly within a town.

All players start out in Crosston (shown as 110 in FIG. 1), where they learn the basics of the gameplay. All players have immediate access to the island of Murinia, where they can get their first taste of the style of gameplay that they will encounter in more depth once they have their own village.

Exploring the wilderness between towns is its own type of gameplay. Towns are linked by spaces of randomly generated wilderness, which must be successfully navigated to get to the next town. On the way items and special events can be discovered.

On Murinia, exploring will be simpler, but also will have less of a reward, than in the villages. Sea exploration will also be based on a similar model as the wilderness exploration. For players, the biggest draw of exploring, however, is to see and find other villages to directly link to the player's own village. A player may find a village with a very unique culture, flora and fauna, with festivities and holidays the player has never experienced. Finding such an exotic location will open up new possibilities for the inhabitants of the player's own village to add new items and games to the player's village.

Both individual avatars and villagers can “level”, although the way in which they do so is different. Avatars gain levels by playing mini-games or engaging in various social activities. Villagers gain levels when the player purchases new figurines in that particular set. Avatar levels and villager levels are tied together in that as the villager gains levels, they open up high-levels of the mini-games associated with that particular figurine. This allows the avatar local access to the higher leveled games.

Many of the games the player can play are based on mini-game types that are either new, or based on existing favorites. For example, Diner Dash®-style gameplay would be tied to visiting the Bakery, while Bejeweled®-style gameplay would be tied to the jeweler of the city or village the player is visiting. In addition, there are many card and strategy games that can be played alone or with groups of other players. It is desired to invoke the relaxed, casual feeling of coming over for tea and playing board games or a game of cards.

Other types of mini-games are the quests, which have the players of the game working together to solve various tasks that are stringed together for a reward. Many of these quests will attempt to pull in players with loosely connected networks of friends to help strengthen friendships, thus tying the players to game more strongly.

Many games encourage multiplayer cooperative play for players to get the highest rewards. In addition, Tail Towns™ includes a gossip system, which almost has a quest-like aspect that is ‘given’ by NPC's and often has to be ‘solved’by two or more players. Solving these gossip quests gives the players special rewards that are exclusive to this system. These quests may often help players meet and befriend others in the interlinked web of local villages.

Intelligent matchmaking helps facilitate social interactions by unobtrusively placing closely linked players in situations together, using the idea of “seven degrees of separation” to build a tight-knit community of players.

As in many MMO's there exists a large virtual world to explore and people to meet. Unlike most MMO's, one focus of the game is to build and maintain a village. It takes more than simply a few people to make a village, which is why players will need to purchase at least one figurine to be part of a village.

With at least a predetermined number, such as eight (8), for example, of characters a village can be born. Four players, with an avatar and a figurine each, is one way to start an initial village. Yet, as long as there are eight or another number above the threshold requirement of characters starting a village, with at least half or more being Figurines, any smaller group of players can start their own villages. Even a single player can have a complete solo village with the minimum of seven purchased figurines in the present example.

Players will be encouraged, through social pressure of other villages, and through the other players sharing their village, to purchase more figurines to help expand the village in its area and scope.

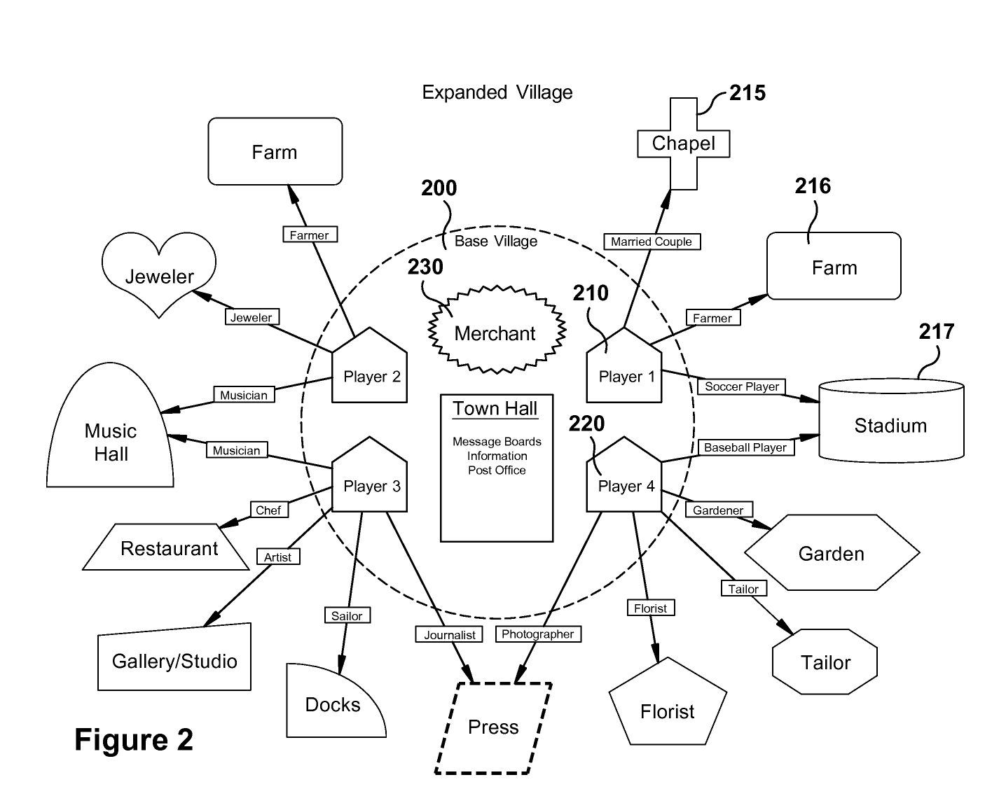

FIG. 2 illustrates how the villages can be expanded, starting at the central base village 200, and adding different elements on to the village, by different players. For example, player number one shown as 210 can be within the village, and can have on different buildings including the chapel to 15, a farm to 16, and the stadium to 17. Another player, such as 220 can have their own buildings, and in fact in FIG. 2 the building stadium 217 is jointly produced by both the players 210 and 220. There can also be certain NPC's within the village, for example shown as the merchant 230. Unlike the avatars, an appearance of such NPC's is not necessarily based on codes entered by users.

Although there will be opportunities for light crafting, within Tail Towns™, the focus will be on actual content creation for art, music and stories.

An image editor allows for artistic players to create patterns which can be used on clothing, cakes, picture-frames, ship sails and more, adding potential value to a town's exports.

A music editor will allow players to compose their own midi songs. A band of virtual musicians can then play the music, or solo musicians can play these tunes in town.

A robust reward system exists to keep players into the game. Whether it is rewarding players for social interactions, exploring, leveling up, playing mini-games, completing a collection or working on a village there are appropriate rewards to keep players interested in the game.

Rewards are not only simply items, but can exist by unlocking levels, new games, events and quests, as well as ranking for the player's Avatar.

Events take place in the player's village, in other friend's villages and in Murinia. These events may change the look and nature of a village, from time to time. Holidays, sports tournaments, market days and such may bring players together for these special activities with unique item and ranking rewards.

Through avatars, the player has a window into the world of Tail Towns™. These mouse avatars are the players' virtual representatives in the game. As such, there will be many ways of differentiating one player's avatar from other players'.

Avatars, as the player's representative, have many attributes and items associated with it. The game also ties the villagers to a particular avatar. Although buildings will be shared.

Villagers are not, and as such they can be considered belonging to an Avatar.

Each avatar character has personal traits that can be initially defined, as well as adornments that can be found, won or purchased in the game for character customization.

To comply with the karma system (see “Karma” above), all items will be divided into three categories: ordinary, naughty, and nice. Avatars progress in the game is recorded in the form of a ranking. Of the two types of rankings, only skill badges are visible, while karma is invisible (to the players). Both types of rankings, however, influence the game's behavior.

The following table lists the villager types. It describes the job title, the building that comes with the villager (if any), and provides a brief description of what this villager does.

| Job Title | Building | Description |
|---|---|---|
| Tailor | Tailor | Creates manufactured clothing items |
| Chef | Restaurant | Cooks food for purchase |
| Blacksmith | Workshop | Makes metal tools and items |
| Cobbler | Tailor | Makes shoes, sandals |
| Haberdasher | Tailor | Makes hats |
| Inventor | Workshop | Makes machines |
| Carpenter | Workshop | Makes furniture and items out of wood |
| Jeweler | Jeweler | Cuts gens, makes jewelry and watches |
| Potter | Gallery/Studio | Makes pots, ceramics |
| Weaver | Tailor | Makes fabrics, baskets |
| Baker | Restaurant | Makes baked goods |
| Florist | Greenhouse | Makes flower arrangements |
| Journalist | Press | Writes & blogs for the community |
| Photographer | None* (can use | Takes photographs |
| | the Press & | |
| | Gallery/Studio) | |
| Musician | Theatre | Plays musical instruments |
| Party Planner | Theatre | Plans Fun Events |
| Politician | None* (can use | Governs how the overall functioning of |
| | the existing | the town is nm |
| | Town Hall) | |
| Athlete | Stadium | Plays sports professionally |
| Married Couple | Chapel | Provides marriage licenses |

Buildings will be assigned to villager types. Some villagers will share buildings, while others will get their own buildings.

Shared buildings refer to whether or not a single building will be used for multiple villagers, of the same and different types.

A ‘single’ villager means that this villager is specifically tied to a single building. If a player purchases this villager, it means the village gains a single instance of this building type per player. This means that a village could have 4 restaurants (one per player), although their ‘skin’ and crafted items might be different than the other restaurants.

‘Borrowing’ villagers will not bring these buildings to a village. They will, instead, wander outside and bring a certain benefit to the town. They are able, however, to use certain buildings, if available. For instance, purchasing a Magician will not bring about a theatre, but as soon as a theatre comes to town, a magician will then be able to have a magic show in the theatre (with new mini-games to play based on magic).

Quests, in Tail Towns™, differentiate from quests in other, traditional MMO's by being mainly about communication within the storyline of the existing villagers, NPC's from Murinia and the other players in the game. Most quests are a string of communication puzzles.

Quests will have rewards given during the quest, and may have a greater reward given at the end of the quest. The only type of non-story questing is the exploration quest, which is designed to find items and establish links between existing villages.

There may be many different kinds of quests. Gossip quests are simple story-based quests that take on the form of town gossip. Villagers will either be triggered to approach a player's avatar, while in town, to try and entice the player into following a gossip quest or a player may approach a villager and find whether this villager has a tidbit of gossip or rumors. If the villager does have gossip or rumors available, it will trigger a series of events that will cause a player to run around and talk to many people. Sometimes, multiple players will be part of a single gossip quest and will cross paths. If two players find each other and join together in the gossip quest, they will be rewarded with a greater prize. This will encourage people to meet and communicate.

One type of gossip quest has players to ‘carry’ a number of pre-scripted story elements, when they encounter another player with the story trigger they need, they can select one of multiple story tree options . . . which, in turn, opens up different branching trees. Following these story trees to the end provides a reward.

Another type of gossip quest will allow players to find and help spread a Rumor and deliver it like a MLM scheme. Players that get it delivered to a target number of people in the shortest amount of time will be rewarded.

Secrets are yet another type of gossip quest, in which a villager's secret speech options may be uncovered. There can be a variety of ways to unlock Secrets, or even to know whether a villager has a secret to uncover.

Exploration quests bring a sense of travel to the world of Tail Towns™, and allows for players to obtain special treasure, play unique mini-games, and most importantly—forge direct links with friendly villages.

Each player will be able to only go on a single exploration quest per day, so this is something that requires concerted, regular effort if links with other villages wish to be established, since there is no guarantee that a direct link will be found per session.

When an avatar enters the “wilderness” for the first time that day, a randomly themed and structured maze-like area is generated, with random item drops.

A player may move to one of a few ‘exits’ which then carries the player to a randomly chosen area: either a new map, a new village, or causes the player to exit the wilderness and ‘pop out’ back home. Any further attempt to enter the wilderness will simply take the player back home, until a day is passed.

If a player finds a new village, a direct link is permanently forged, and all of the village's players will be able to select that village from a list and transport there directly, at any time and frequency.

Also, some maps are of a special “bonus Map” type such as a gypsy carnival. In this example, the player would meet with mouse gypsies and play games of chance to win mysterious and rare prizes, or possibly lose a small fortune.

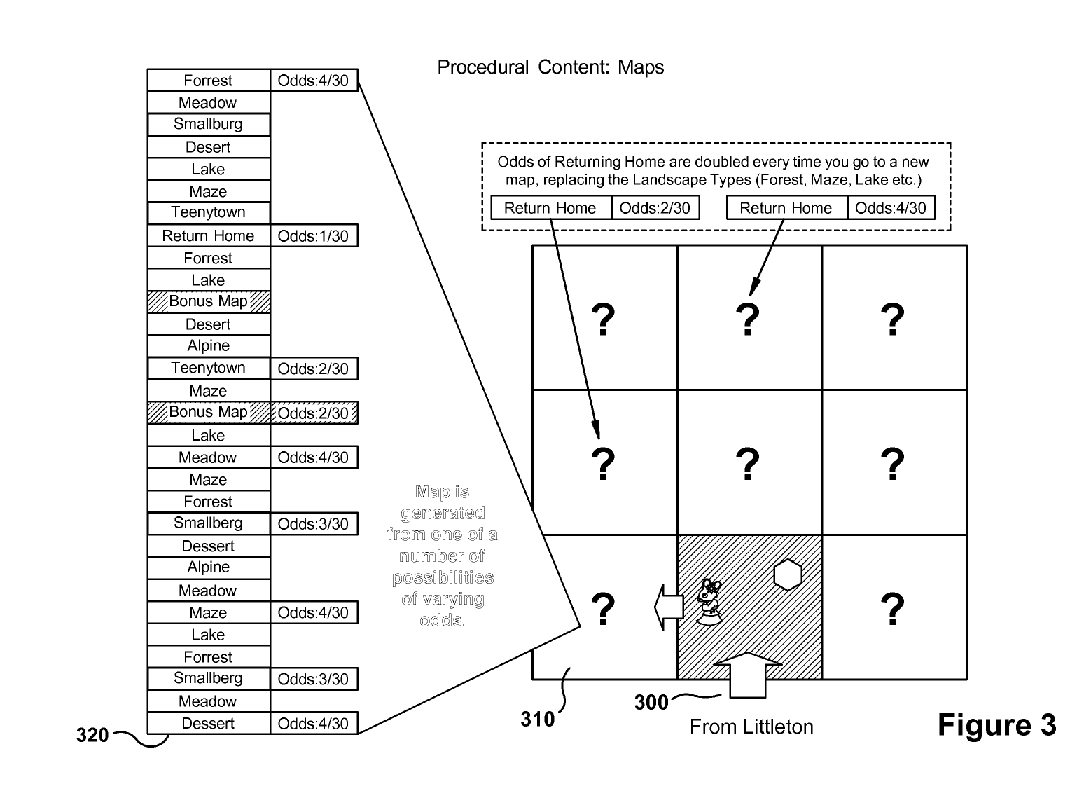

FIG. 3 shows how different maps can interact. The user may arrive at 300, and from that arrival can go in any of a number of different directions. Any time the user goes in the direction such as towards map 300, their odds of where they end up may be set according to the map table 320. The odds of returning home double every time a player goes to a new map, and the map itself from to which the user arrives may be generated from one of a number of possibilities of continuously varying odds.

Cooperative multiplayer games are designed to bring players together to solve a certain task. Players actually play separate games, but these games have an influence over the other, and the prize awarded is based on how well both players do. Cooperative games try to give the illusion that there is a hard, direct correlation between the two games being played, although, in actuality, the correlation is soft. For example, if the two players are playing a cooperative restaurant game, one player might be the chef, while the other is the waitress. Items that the chef cooks will trigger items to appear for the waitress to serve, although the number and timing of such food items will not be exactly what the chef is cooking in real time. If the two players were sitting next to each other, they would notice that there was a discrepancy. What matters, however, is that how well the chef plays his individual game, gives a bonus to make it easier for the waitress to play her game, and vice versa. Other games are similarly structured, although details will be different. Playing villager-based cooperative games repetitively also rewards players with a slight nice karma ranking.

There may seem to be a hard, direct correlation between the two games being played, although, in actuality, the correlation is soft. For example, if the two players are playing a cooperative restaurant game, one player might be the chef, while the other is the waitress. Items that the chef cooks will trigger items to appear for the waitress to serve, although the number and timing of such food items will not be exactly what the chef is cooking in real time. If the two players were sitting next to each other, they would notice that there was a discrepancy. What matters, however, is that how well the chef plays his individual game, gives a bonus to make it easier for the waitress to play her game, and vice versa. Other games are similarly structured, although details will be different. Playing villager-based cooperative games repetitively also rewards players with a slightly nice karma ranking.

One embodiment may be a game with a heavy emphasis on social networking. In social networking games, friends are the staple of the community. There are numerous ways to bring existing friends into the game, or to make new friends in the game. Friends can be gathered or met in the game by a variety of ways.

Email Invites: Just as many social networking apps have bots that send automated emails from a user's existing network of friends, the Tail Towns™ system includes this feature to encourage players to bring their friends along. Since Tail Towns™ has a robust free-to-play mode, it is believed that the free-to-play mode will serve as a potential way of bringing multiple players into the game.

Social Network Apps: By building apps, with major social networking applications such as Facebook® or Myspace®, a crossover to the world of Tail Towns™ can be established. For example, a 2D avatar representative and simple apartment flat may exist on Facebook®. This free app is tied to a server hosting the website so it can be known what items and customizations users have. This app will have a button that takes the player to the website as soon as they wish to play with a more robust 3D version (which takes them into the game environment where potential membership sales can be made).

Communication: Any communication with another player in the game will include an option to add this user as a friend. If the other player accepts, then both the user extending the invitation and the recipient will have a new friend in their friends list.

Playing Games: Playing games with other players will put them on a temporary “recently-played-with” list. Any of these people can be converted to a friend quite easily by selecting their name and the option to add them to the friends list.

Inviting to a Village: Any player can give an invite to another player to visit their village. Just like the recently-played-with list, players who have visited a village of a particular user will also be on a temporary list for that village for a limited time. While those players are on this list, they can be added permanently to the particular user's friends list.

Village Mates: Any other player who lives in a village of a particular user will automatically be added to that particular user's friends list.

To help bring together, the game will have a visible and invisible matchmaking system that is designed to help bring players together in the hope of building and strengthening friendships.

Each player has a friends list that is easily accessible. Since, like social networking apps, this friends list can fill up quite easily there are sorted categories to help players manage the friends that they have. Invitees are kept in a separate list, which may contain a limited number or the most recent invitees to visit a player's village. Players may give invitations (shown as an envelope) to any player that they see fit.

Once an invitation is given and received, the players are listed in each other's Invitee list for a period of time. If the invitation is held and used later, the invitee list is refreshed with the players once again for a limited time. Of course, while a player is in the invitee list, they may request to be added to the more permanent friends list during the duration of the invitee period.

Recently-played-with players are also kept in a separate list, just as Invitees are. This is also a time-limited list, and gives players a chance to reconnect with other players that they enjoyed playing with. Before the recently-played-with list has expired, the other player from being listed, either or both players may choose to add the player, quite simply, to their group of friends.

As soon as players form a village together, all other village-mates will be automatically added to each other's friends list. If and when villagers choose to leave or disband a village, they will be strangers again and will need to manually add each other to their friends list. This is done to give players an option of leaving bad village mates behind without their whereabouts and activities being instantly accessible.

Friends of friends also forms a list of friends will be hidden from the player, but will be accessible by the server and its matchmaking algorithms. Friends of friends will be tracked by a number of degrees of separation.

This data is used for a number of matchmaking functions to bring people who know people together. By filling in the gaps between the degrees of separation, it is desired to create a web of interactions that seem almost uncanny to the user how the person they might have played a seemingly random multiplayer match was a friend of one of their good friends. Although some of these potential friendships may fizzle out, it is very likely that others will turn into strong friendships, strengthened by the fact that they now know common people.

Players will have a variety of methods to communicate through the game. This will allow all players to communicate in the way that they feel that best suits them.

When players start the game, and are initially learning the ropes in Murinia, the players will have the same font and speech bubble style as their fellow Murinians. When a player moves into a village, however, an accent will be assigned to the player, although the results of this accent will only be visible by looking at another player's computer monitor while the player is talking to them. Basically this means that everyone seems to have a “normal” accent, but to other players it will seem like all other players have a different accent. Linked villages will eventually be able to get used to each other's accents, meaning they will return to normal for each other (although color of text or speech bubbles may be different).

Villagers and NPC's may comment on a user's accent and pretend to mix-up what the user is saying.

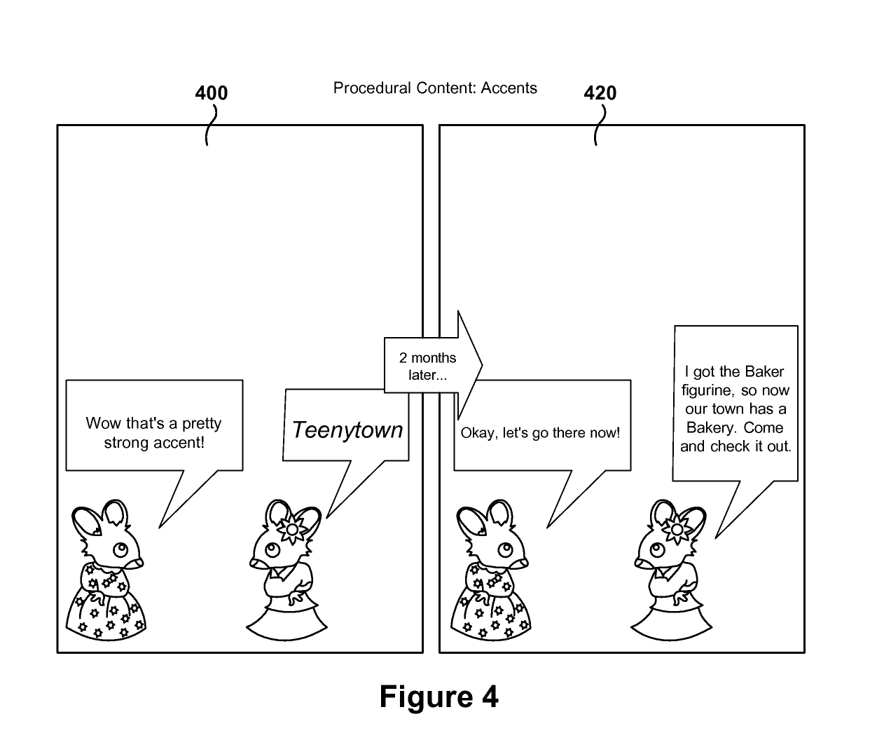

Although there will be repeats of accents, this will hardly be noticeable anywhere but Murinia, as most linked villages will quickly change to a normal accent. FIG. 4 illustrates how initially, at times 400, when player's avatars talk, others perceive an accent in their speech. However, at a later time at 420, the accent will have faded.

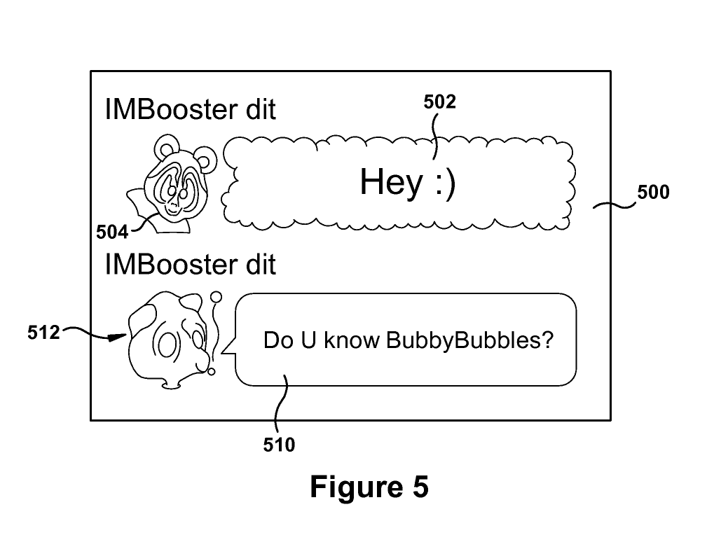

In operation, when users speak, they may receive the screen shown as 500 in FIG. 5. The instant messaging (“IM”) service will show a virtual image of an avatar's face, as well as a cartoonish speech bubble for when the avatar speaks. The font and style of bubble of the player to whom the message is intended will be determined by their accent. A user may change his own font and bubble style only for that user's own benefit. The other player will see the user's avatar font and bubble style as a representation of the Accent of the user's avatar.

According to one embodiment, an emotional markup language, or Emo-ML, is used to allow avatars and villagers to display certain emotions during chat sessions. A sender who types the string :-) during a chat will make the sender's avatar smile, for example as shown by the : ) in 502, resulting in smile 504 appearing on the avatar's face. Typing an exclamation mark will widen the avatar's eyes. Typing two question marks 510 will result in the player's avatar scratching its head at 512. More generally, typing of text characters as an indication of an emotion during the communication causes the avatar to be animated in a way that shows the avatar's emotions. The indication of the emotion made up of the text characters entered as part of the chat message includes characters that do not form a word in a language in which the chat message is written. For example, the string :-) includes only a punctuation mark in the form of a colon, followed by a dash (-) and a closing parenthesis, a combination that does not form a word but represents the smile emotion.

The animation of the avatar can optionally occur simultaneously or contemporaneously with the presentation of the content of the chat message to the recipient. In this manner, the avatar's animation provides an emotional context to the chat message.

Secrets are unlockable text options that may be found when talking to villagers and NPCs. Prying a secret out of an NPC will require some kind of quest to assist that NPC in some way. When talking to an NPC, there will be a visual indicator (NYD) that will show whether an NPC has a secret. This NPC will also need some kind of assistance (e.g. a quest). The player that finishes the quest first will be the one to unlock the secret, which will lead the player to special quests.

Speech bubbles are part of both the instant messaging as well as the common way for the characters to communicate with each other, in the world, in real-time. When a player speaks with a villager or NPC, the dialog will be pre-scripted. The player will choose from a variety of options to say, and once this is selected, it will be displayed as a speech bubble. The villager/NPC will respond to this appropriately in his own speech bubble. Conversations done this way are private, and will be separate from the chatroom style of chat in which all players may hear.

“Quest chat” allows players to have automatic, pre-scripted story-based text options to say to other players. If a player talks with another player, and these text messages are available, they can select them instead of typing. This will trigger the other player to have automatic, pre-scripted messages in response. Following these story threads will tell a story that can lead the two players to join in on the quest together.

Karmic Flavors: Actions, which affect karma, are divided into two separate flavors, nice actions and naughty actions. Nice actions are those which help or benefit other players while naughty actions are those which cause light-hearted mischief. Naughty karma is not really a punishment. It is actually a type of reward that encourages a certain mischievous social interaction. Often edgy-styled items with a tongue-in-cheek sense of humor are what the players will find as their rewards. For instance, a player who plays a lot of tricks on other players will get tagged with naughty karma. When this player goes to the shop, she might find tattered clothes, crooked beds, cobweb curtains, black/grey/purple colored items etc. as well as the normal, neutral items. If this player maintains her naughty karma AND purchases and keeps the naughty items, this player could theme her avatar, home and village with such themes, giving a distinct look, flavor and style to her belongings. If an entire village decided to be this way, the players could then make a very funny and strange village with crooked trees, black flowers, strangely skinned buildings, mischievous villagers and uniquely themed event items, such as a rickety-rollercoaster in the carnival, spider-pies in the bake sale and such. For nice karma, sweet, angelic styled items and enhancements will flavor what the players get and experience instead. This will help create diversity in the player's villages and encourage and strengthen multiplayer social interactions.

Karmic Delivery: The core mechanic of altering karma is through giving. Players have the option of sending packages through the mail. All packages will be automatically wrapped up as a gift, but not all contents will be necessarily of a gift-like nature inside. Some items will be tricks, although the recipient will have no idea what is inside. When the recipient opens the package, the trick will be sprung and the effect will take place. Effects, such as a simple pie-in-the-face may last for up to 10 minutes or so. Gifts are simply items that players wish to give to each other.

Quest for Karma: Karma can also be rewarded for how a player plays certain quests. Some quests may have elements of being nice to each other, while other quests have a type of naughtiness about it (The naughtiness will be very silly and only false-malicious at worst). A nice quest might be about getting ten signatures on a “We Miss You” card for a certain player who has been away for a long time, while a naughty quest might be about getting a rumor (Josie's house is infested with bugs!” delivered by word-of-mouth to five full villages of players or twenty single villages of players.

Nice/Naughty Fun: Since a very strong emphasis will be on cooperative multiplayer games, there will be occasional opportunities for a little bit of niceness or mischief. For example, if two players are playing chef-based cooperative games, where one player is playing a waiter in a Diner Dash® clone, while another is playing a chef in a cooking game and during the game they are helping each other to do better. The faster the chef cooks, the more the waiter benefits, by having food available for customers faster (not directly, one-on one faster). The better the waiter serves, the more money the restaurant makes, which buys fresher ingredients for the chef to cook with, thus improving the chef's quality and score. Now let's say that a waiter receives some tips. The player controlling the waiter can give the chef a larger percentage than normal and gain nice karma. The waiter could also send a cockroach to the kitchen to raise havoc as an in-game trick and receive naughty karma. The chef could put glue on a plate which would stick to the waiter's hands and get Naugty karma, or garnish the plate to get the Waiter praise and receive nice karma. Games may also reward items that have a karmic-theme depending on the players existing karmic value

Effects: Karma (marked by a green rectangle) affects many of the game's components.

Secret Goods: The Merchant will sell a few extra items depending on a player's karma. Since a player will not have any idea what their karmic value is, this will initially seem like a mystery why these items appear at times, and not at other times.

Karmic Collections: A player's karma will add some special items as rewards for mini-games or in the Merchant's shop. As long as the player remains at this level of karma, these items will be available, but if the player dips back into Neutral karma territory, these items will not be available. Players will be able to add such items to their collections of stuff.

Themed Animations: When a player has a certain karmic rating, the player's animations may change. For example, a player with naughty karma may have a diabolical laugh or snicker. While a player with nice karma might have a friendly wave. Since players will not be able to directly see what they have for karma (or even that it exists!) they will wonder and try to figure out why these animations changed at this time.

Tainted quests: Players with a strong karmic alignment, in one way or the other, are given quest opportunities; from time-to-time to help enhance their already existing karmic alignment. So Rumor quests will become more frequently available to players with already naughty karma and giving quests will be more frequently available to players with already existing nice karma.

Enhanced Events: If a player, or village of players, has a karmic alignment in one direction then events may have special themes/enhancements that are different than normal. Carnivals may have rickety, scary and mischievous rides if the village has mostly naughty-tinged players, while a Festivus event may have extra presents for all, if they have particularly nice karma.

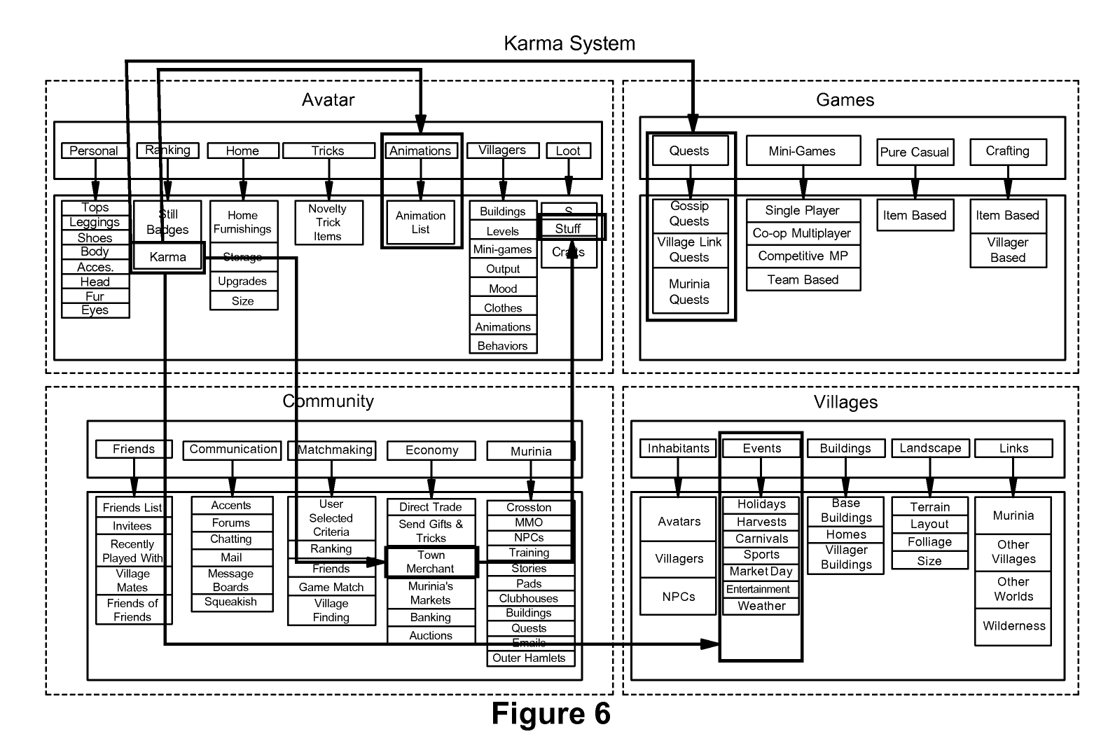

The operation and relationship of the karma system is shown in detail with reference to FIG. 6.

Another aspect of the present application relates to the Tail Towns™ sync server. The sync server provides high-speed, scalable, fault-tolerant message exchange and object synchronization capabilities among Tail Towns™ end-user client workstation. The sync server is built using the Ganz Service Framework (GSF).

The sync server provides the management and communication infrastructure for synchronization of characters, events and environments across the Tail Towns™ user base. Being a GSF server, it immediately benefits from the communications support, transaction execution model, data marshaling, server discovery, performance monitoring, and configuration management capabilities inherent in GSF.

This document describes the major components of the sync server and its interactions with other servers in the Tail Towns™ server framework.

The Tail Towns™ sync server can be embodied as a cluster of GSF-based servers. These servers collectively manage the synchronization of data across all user sessions for the Tail Towns™ environment.

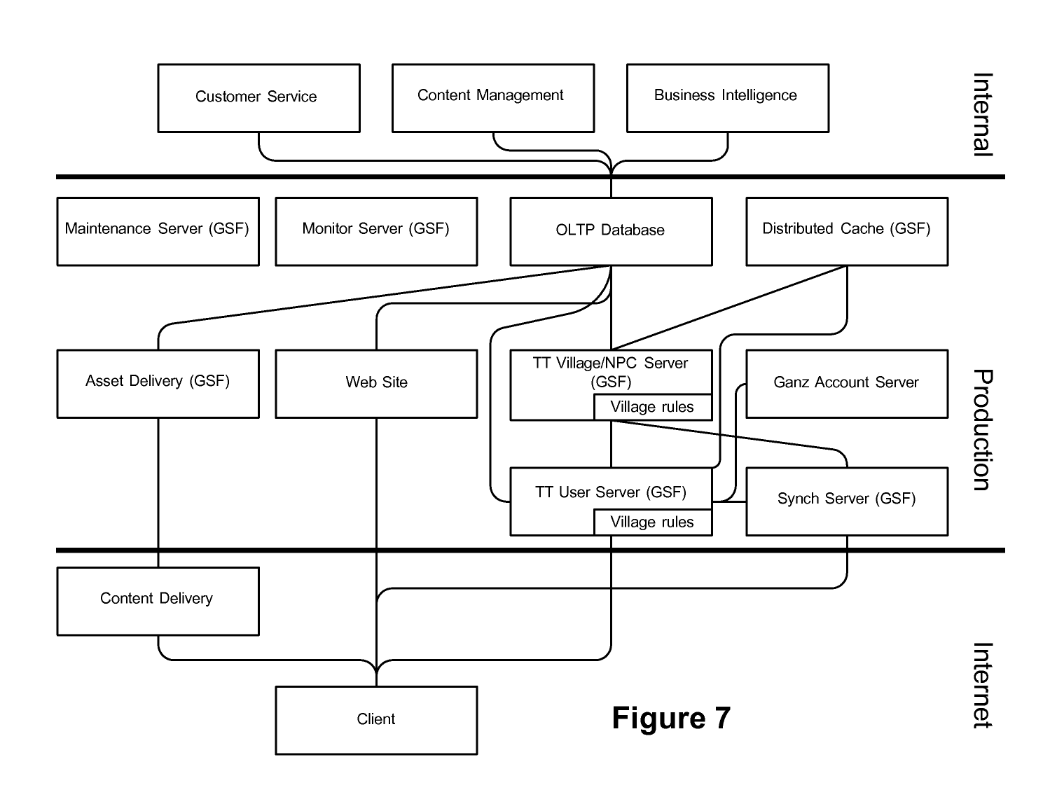

FIG. 7 shows an illustrative relationship of the sync server to other server clusters in Tail Towns™.

Sync servers distribute messages to clients based on internal filtering rules that are designed to provide meaningful, consistent-over-time exchanges that minimize traffic to the client. Traffic reduction is necessary to ensure that the client isn't overloaded with messages about which it has little or no interest, and to control outbound network utilization.

Each sync server manages messages to clients for a set of villages. The grouping by village keeps natural collections of users connected to the same server, thereby encouraging more optimal communication. When clients are chatting with users in other villages, or when transient load rebalancing results in the relocation of users or an entire village, the sync server infrastructure automatically forwards messages to the appropriate server. This process allows any sync server to act as a proxy for message distribution.

The sync server tracks performance statistics and operational data using the GSF monitoring system. This system tracks hundreds of vital server properties including CPU, memory and JVM values at regular intervals. It also tracks defed information about API calls (such as counts and response times) made from the other servers, communication message counts, and filtering results. All values can be managed, tracked and displayed through the browser-based GSF monitor tool.

Performance statistics specific to the sync server include measurements related to villages, users, and message fan-out. Another important sync server-specific statistic is the village load factor (VLF), which is computed for each village hosted by a server. The VLF is a representation of the percentage of time the server spends servicing that particular village. The VLF is disseminated as part of the server allocation protocol, outside of the periodic GSF performance messages.

The sync server provides functionality to other servers in the Tail Town™ complex through an exposed set of APIs. These APIs offer functions for the user and village servers, as well as for client browsers running Tail Towns™.

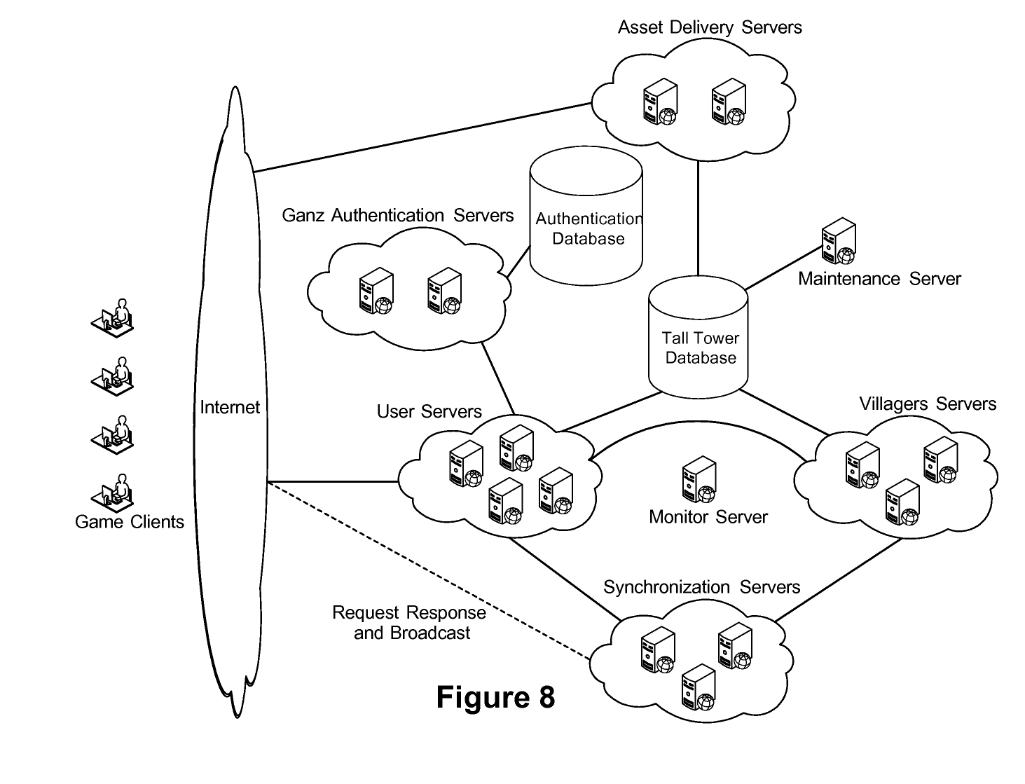

FIG. 8 illustrates the communication paths among Tail Towns™ servers. Game clients have communication channels to a user server and to a sync server. Most of the client's transactional requests are performed through the sser server, which is able to disseminate resulting changes to any affected clients through the sync server cluster. Transactions that impact villages are routed by the user server to a village server, which likewise can disseminate changes through sync servers. The sync servers use their direct channels to the clients for which they have responsibility to fan out and distribute object changes, state changes, player moves and actions, and chat correspondence, as well as system notifications.

The channel between the client and the sync server also provides a short-circuit up-link path for elementary operations such as moves and emotes. Avoiding having these dominant messages go through a user server saves a network hop and reduces contention on the user servers, both of which serve to improve the overall responsiveness of the game experience.

Client-server connections may be either TCP or reliable UDP, according to constraints imposed by network, firewall, and software configuration choices made by the client. Reliable UDP is preferred for the downstream broadcast traffic from the sync server, as it has better scaling characteristics and often results in improved transmission speed. However, alternate embodiments support both protocols and to allow the client to participate in the choice of which (or both) to use.

The sync server does not connect to a relational database for the information it requires, and instead queries a user or village server to collect information about users, NPCs or villages that may be needed to drive synchronization and filtering logic. Recognizing the user and village servers as the systems of reference for their respective classes of data allows these other servers to keep updates in dCache or in local memory without committing them to the database. In turn, this model provides excellent flexibility in how data is organized while offering exceptional performance and scaling characteristics.

The sync server itself does not need to make use of dCache, since the data classes that it maintains either have servers that act as their systems of reference (as just described), or else is shared across a subset of sync servers known precisely to the sync server cluster. Moreover, all of the data in the latter category is extremely transient. For this reason, a sync server can always obtain synchronization data that it requires from a peer server.

The user server makes use of the sync server to communicate changes to a player's appearance, location, actions or emotes, and also to pass notifications and chat messages to clients.

The village server makes use of the sync server to communicate NPC information including scripting and other visual changes. Also, the village server uses the sync server to communicate any updates or additions and deletions to a village to clients including the launching of events and the associated NPC interactions.

To perform its core functionality, the sync server works with three main entities: villages, locations and users. The sync server's view of these objects is limited only to the essential pieces of data that are required for its functionality, and may differ from the object model used by the database or other servers.

Associated with any instance of each of these entities is a version number which is updated with each change to the object. When the sync server provides entity details to a client, it typically provides the entity's ID and the version number. This allows the client to cache objects locally and request the latest version (via the user server) only when the sync server notifies it of a change in version.

Entity data cached by the sync server itself is retained only to the extent that the server requires it to perform its intrinsic functionality. Specifically, the sync server does not attempt to keep a cache of all village or user properties for objects that it is mediating. The server may publish updates to objects as a pass-through from a user or village server, without needing the complete picture of the entity.

The synchronization for each active village in Tail Towns™ is managed by one or more sync servers, and each sync server typically manages synchronization for multiple villages.

For each village currently managed by a sync server, the server caches the complete set of NPCs active within the village, and their current task list and paused state. The village server is responsible for all additions, removals and changes to NPCs; the sync server is responsible only for caching the data, providing a complete snapshot to any connected user that enters the village, and relaying any changes received from the village server to any connected users in the village. The sync server also maintains for each village the set of locations that comprise it, as well as the complete list of all connected users currently in the village.

Each village is divided into a number of locations. Each room or floor within a building is a location, as is the village's exterior. To the sync server, each location is a fixed-size, two-dimensional space. Each village can contain a number of objects at a specific locations (e.g. televisions, sofas, fountains, buildings, etc.), as well a number of users who are often moving within the location. Addition, removal, or change in the position of an object (not a character) within the location is considered a change to the location itself and results in an increment of its version number. This allows a user who has left the location and returned to determine whether its cached version of the location is still valid (as it typically is). Unlike objects, arrival, departure, or movement of a user does not result in an increment in the location's version number.

NPCs, similar to the users' avatars, also move from location to location and within locations. These movements, however, are scripted well in advance, and their implementation is the responsibility of the client application. For each location, the sync server maintains its length, width, and a complete list of users that are currently within it. The list of users is divided across a set of spatial indices (Sis) that partition the location into a regular grid.

The sync server maintains the following data for each user in a village (including those who are connected to other sync servers that are co-hosting the village): List of connected users who can see the user in question. This is the list of users who must be notified of any of this user's movements.

Most-recently calculated SI. This is the spatial index of the last-known location occupied by the user.

Current position or latest movement path In addition to the general “whereabouts” data above, the sync server also maintains the following information, used as inputs into the visibility algorithm:
Language ID
Region ID
Home village ID

For users who are connected to the sync server, the following additional information is maintained for the purpose of visibility calculations:
List of other users whom this user can see
List of users this user recently saw
List of friends of this user
List of users with whom this user is currently grouped

The core function of the sync server is to relay changes in the game world to connected users, to ensure that all users have a synchronized view of the Tail Towns™ world. The most notable source of change is player movements within a location. While the sync server sends notifications only to users who are in the same location as the object that has generated the change, the limited resources of both the client and server (as well as the network between them) coupled with the potential for very busy locations within Tail Towns™ necessitate that some players and NPCs occasionally be filtered from the view of the location presented to the user.

Filtering is implemented on both the client and server. Server-side filtering is primarily used to reduce the potentially high-bandwidth stream of arrivals and movements of characters that are of little or no relevance to a particular user. Client-side filtering is employed to limit the graphical rendering processing expended by the client application so that it is proportional to the specific capabilities of the client hardware.

The data required to perform filtering is cached by the sync server and generally updated periodically through background agents. This data typically consists of scalar properties and lists of users, organized by user and location. Because the data is designed to support local-to-this-server decisions, it encapsulates a local view of a village. Some properties, such as the list of users in a village, are maintained globally, but the detailed knowledge of users is strictly local. In this way, data maintenance and sharing is handled optimally.

When a user enters a location, the list of users whom the newcomer can see is computed immediately and synchronously, rather than waiting for the next iteration of the appropriate background agent.

Server-side filtering for a given user begins with a rough proximity sort. Any characters determined to be “far” from the user are immediately filtered from the update stream, regardless of their relevance to the user. Any users determined to be “near” the user are candidates to be included in the update stream, subject to relevance filtering. Any characters located within a spatial index of which any portion can be seen by the client (assuming the longest camera setting) are considered “near;” all others are considered “far.” No further weighting based on proximity is considered by the server-side filtering mechanism. (Favoring characters based on relative proximity would require significantly more CPU resources, as well as tending to produce a claustrophobic user experience.)

Beyond proximity, the sync server does not include the user's field of vision into its filtering criteria. In particular, the user's current angle of rotation (i.e. the direction in which the player is looking) is not considered, as this value can change very quickly and demand much more frequent calculations of the visibility list. Occluded users and objects are also not filtered, as the sync server is not running a complete game simulation and is therefore not in a position to perform line-of-sight, collision detection, or path-finding calculations.

Once the partition of nearby candidates has been determined, each is given a relative weight according to the criteria described below. These criteria are presented most to least relevant.
Talking/interacting. Characters with whom the user is currently grouped or is actively chatting.
NPCs of importance: Crucial NPCs (e.g. quest givers, etc.).
Friends: Characters controlled by friends of the user.
Village mates: Characters controlled by users with the same home village (excluding Starter Town).
Currently seen: Characters currently visible to the user. In order to provide a sense of temporal consistency, the filtering mechanism biases toward keeping currently-seen users in the update list, even if another character of marginally-greater relevance has arrived.
Friends of friends: Characters controlled by friends of the user's friends.
Recent interest: Characters who were recently seen by the user (temporal consistency).
Can see me: Characters who can see the user (mutual consistency).
Regional language/dialect: Characters who speak the same dialect as the user.
Language: Characters who speak the same language as the user, but possibly a different dialect of it.
Region/locale: Characters from the same part of the world as the user.

After the weight for each candidate has been calculated, the top n (where n is the target number of visible users) are chosen and become the new list of visible users. For each user who has been added to the visibility list and each who has been removed from it, the inverted visibility lists associated with that user are also updated. Clients are notified of additions and removals to and from their visibility lists, as well as changes in the weight associated with a visible user, via the AddPlayerNotify, RemovePlayerNotify, and ChangeWeightNotify messages, respectively.

When a user V is added to user U's visibility list, and U and V are hosted by the same sync server, U is reciprocally added to V's visibility list immediately with a low filtering weight, provided V does not exceed its target number of visible users. This ensures a timely mutual consistency for sparsely-occupied villages (those where gaps in consistency would be most likely to be noticed).

Most types of server interaction initiated by the client are directed to the user server. Because the user server has a complete view of the user's state, inventory, and relationship with other users and villages, its business logic is uniquely in a position to vet incoming requests and to reject those that are deemed inappropriate. This can include taking action if a hacked client application is suspected.

Unlike the user server, the sync server has a very limited view of the state of a user and is unaware of most of the ways in which a user is interacting with the Tail Towns™ world. The sync server is, however, the authority with respect to where a user is positioned within a particular location, and is the only server situated to perform any form of validation as a user moves from position to position within a location. In particular, the sync server can detect any movements that are perceived to be discontinuous (“teleports”), implausibly fast (“speeding”), or fall outside of the bounds of the location. If a validation test is computationally complex, the sync server may choose to perform it on a periodic spot-check basis.

Note that the sync server does not test for blocked paths (such as might occur if one tried to walk through walls or other obstacles). Path analysis of this sort occurs only on the client. Global consistency is assured by virtue of the fact that each client reaches the same conclusion regarding the path to take between two points, based on its knowledge of the terrain. Sync 12

Each sync server is responsible for handling a community of users (unique across the sync server cluster), and one or more villages (which may or may not be unique across the cluster). Ideally, users are distributed among sync servers based solely on the distribution of villages, with the aim being to keep users who are in the same village aggregated on the same sync server. The sync server assignment is determined by collusion with the sponsoring user server at login time, and is re-evaluated periodically and whenever the user navigates to a different village.

Load balancing algorithms and management are similar to those employed by the village server, with the notable exception that multiple sync servers may share the load of a village by partitioning the user community associated with that village. Most changes in the load management approach between the sync server and the village server emanate from this difference. A corollary of this is that sync server village binding needs to consider both the village as well as the user.

The list below summarizes the salient design assumptions associated with user and village binding:
Village allocation/de-allocation occurs relatively infrequently compared to village interaction.
A village may be hosted by zero, one, or more than one sync servers.
Interaction with sync servers is zero-hop in the typical case.
It is highly desirable to aggregate all users within a village on a single sync server, and to know that the responsibility for the village is not shared.
Introduction of a new server into a cluster does not require rebalancing the load carried by the existing servers. Other forces (both natural and otherwise) will encourage rough balance over time.
An administrator can force all or part of a village hosted by a particular sync server to move to a different server if it's in trouble. Each sync server is empowered with the autonomic behavior to allow it to initiate this hand-off automatically.

Generally, all users in a particular village are assigned to the same sync server. However, to avoid load imbalance with popular villages, the system allows splitting of the user base for a village across multiple sync servers.

The list of villages allocated to each sync server is known globally within the cluster. This knowledge allows a message destined for a particular village to be addressed to any server in the cluster in the absence of better local information. The response to the message may include information about which server actually processed the request, to allow the caller to cache this association and make an optimal choice for future messages. When a village is relocated to another server, the server receiving the message knows where to forward it in the event it cannot process it itself.

Load balancing and user/village binding make use of GSF features to handle unpreferenced routing, as well as to permit each server to obtain a holistic view of the sync server cluster. The discussion below describes how user servers interact with sync servers, but the process is analogous for the interaction between village servers and sync servers.

User servers employ GSF server affinity to associate a known village with a sync server; if a user server is aware of multiple such associations, only the latest is retained in the mapping.

Each user server has its own local notion of affinity, but this notion will eventually agree across all user servers (ignoring transient conditions, discussed later).

When a user logs in, the user server sponsoring the request issues a FindServerSvc transaction to the sync server associated with the user's village, if there is such an established affinity. If a user server has no known sync server affinity for a village, GSF chooses a server at random and directs the request to it. GSF repeats the process until it successfully delivers the request or until no available servers remain. This retry process handles situations where one or more sync servers are offline due to software, hardware, or networking failures. Each sync server has a perfect (ignoring transient conditions, discussed later) view of the assignment of active villages to servers. This is maintained through sync server BindVillageNotify cluster broadcast messages issued whenever a server allocates or de-allocates a village. (Sync servers do not, however, have a global view of the assignment of users to servers, as this information is too dynamic; instead, each server knows of this information only for itself.)

The sync server that receives the FindServerSvc request is responsible for coordinating the assignment of user/village to a server (not necessarily itself). When a sync server receives a FindServerSvc request, there are immediately five possible cases:
1. If the sync server does not host the village and one other sync server does (a transient case), it forwards the request to an appropriate server by issuing a conditional BindSvc transaction and mediates the response back to the requester. In very unusual cases, this forwarding may happen more than once, transparently to the inceptive requester.
2. If the sync server does not host the village and more than one other server does (a transient case), it sends a BindQuerySvc to each hosting server, stopping early if a server indicates that the user is bound to it.1 If the user is not bound to any server, the coordinating sync server chooses the server with the lowest village load factor (VLF) and sends an unconditional BindSvc transaction to it.
3. If the sync server does not host the village and no other server does, it decides which server will host it. This decision is based on a combination of recent Qdist latency to each server, and recent load factor (LF) computations made by each server and disseminated throughout the cluster. In practice, this rarely amounts to much iteration, since an extremely high percentage of villages are hosted by one or at most two sync servers, and since the user server has to issue the FindServerSvc call only at session establishment (connect or reconnect). The proxy for LF is recent Qdist of non-idle CPU.2 The request is sent to the chosen server via an unconditional BindSvc transaction.
4. If the sync server hosts the village and no other server does, it accepts the request and binds the user locally if not already bound (a situation that may occur if the user server is restarted and loses its sync server association for its active sessions).
5. If the sync server hosts the village and at least one other server does as well, it checks to see if the user is already bound locally. If it is, the server accepts the request; otherwise, it sends a BindQuerySvc to each co-hosting server, stopping early if a server indicates that the user is bound to it.3 If the user is not bound to any server, the coordinating sync server chooses the server with the lowest village load factor (VLF) and sends an unconditional BindSvc transaction to it.

GSF will maintain these properties and optionally disseminate them periodically through multicast messages targeted to the cluster. As in Case 2, iteration here is unusual. When a sync server accepts a bind, it adjusts its tables sufficiently for it to recognize and validate a request to open a connection from that user. If such a request does not arrive within a configurable timeframe, the bind is dropped.

Since villages may legitimately reside on multiple sync servers, the case where two sync servers receive unconditional BindSvc requests to allocate a village simultaneously (as can happen if two other sync servers reached different conclusions regarding the best host for a new village binding) is allowed. It is left to village hand-off to amalgamate the users eventually.

A hint in each sync server FindServerSvc response indicates the sync server that actually hosted the query. The requesting user server uses this information to update its local village affinity table, typically yielding zero-hop behaviour for future requests for that village from that user server. The association is also kept in the session information maintained by the user server. Note that a user server does not need to keep a full map of all villages to sync servers; it need only maintain an affinity map for villages of recent interest to it. A user server's imperfect view of the world (perhaps due to village hand-off) is immediately handled by a sync server's ability to perform request forwarding if required.

As load patterns fluctuate, it is desirable to allow co-hosted villages to be consolidated on one server where possible (termed village hand-off), and to allow villages with high VLFs to be split across multiple servers (user hand-off). Both forms of hand-off are facilitated by a shared global view of the sync server cluster.

Periodically, a hand-off task examines the server's LF and the VLF for each village hosted. There are six cases, described below:
1. Moving a village. A united village is a candidate for hand-off from server S to Sh if:
   a) A village has not been handed off to or from S or Sh within a recent configurable period (perhaps 5 minutes); and
   b) S's LF reaches or exceeds a configurable threshold (perhaps 85%); and
   c) The village's VLF as a percentage of the total of all village VLFs on S lies between two configurable thresholds (perhaps 25% and 75%); and
   d) Sh's LF does not exceed a configurable threshold (perhaps 50%)
2. Aggregating a village. A divided village is a candidate for hand-off from server S to cohosting server Sh if:
   a) A village has not been handed off to or from S or Sh within a recent configurable period (perhaps 5 minutes); and
   b) The village's VLF as a percentage of the total of all village VLFs on S does not exceed a configurable threshold (perhaps 10%); and
   c) Sh's LF does not exceed a configurable threshold (perhaps 50%); and
   d) Sh's VLF for the village as a percentage of the total of all of its village; and
   e) VLFs does not exceed a configurable threshold (perhaps 75%)
3. Moving all of a server's portion of a village. A divided village is a candidate for hand-off from server S to non-co-hosting server Sh if:
   a) there is no suitable co-hosting server candidate; and
   b) the criteria for hand-off of a united village from S to Sh (Case 1) apply;
4. Splitting a village. A united village is a candidate for user hand-off from server S to Sh if:
   a) a village has not been handed off to or from S or Sh within a recent configurable period (perhaps 5 minutes); and
   b) S's LF reaches or exceeds a configurable threshold (perhaps 85%); and the village's VLF as a percentage of the total of all village VLFs on S reaches or exceeds a configurable threshold (perhaps 80%); and
   c) Sh's LF does not exceed a configurable threshold (perhaps 50%)
5. Aggregating part of a server's portion of a village. A divided village is a candidate for user hand-off from server S to co-hosting server Sh if:
   a) A village has not been handed off to or from S or Sh within a recent configurable period (perhaps 5 minutes); and
   b) The village's VLF as a percentage of the total of all village VLFs on S reaches or exceeds a configurable threshold (perhaps 40%);
   c) h's LF does not exceed a configurable threshold (perhaps 50%); and
   c) Sh's VLF for the village as a percentage of the total of all of its village VLFs does not exceed a configurable threshold (perhaps 75%)
6) Moving part of a server's portion of a village. A divided village is a candidate for user hand-off from server S to non-co-hosting server Sh if:
   a) There is no suitable co-hosting server candidate; and
   b) The criteria for user hand-off of a united village from S to Sh (e.g., Case 4) apply.

Hand-offs require colluding between the two sync servers involved the operation, and also require notifying affected clients that a different sync server is about to take responsibility for their session. The server that initiates the hand-off starts the process by sending the VillageHandoffSvc to the target server. This service streams the relevant contents of the village, along with user state information, to the target; one or more invocations of the service may be required to transfer all data. (A configurable parameter determines the fraction of the existing village workload that is handed off to the target server during user hand-off.) The initiating server then sends the ChangeServerNotify to each affected client. Next, the server drops connections for the users it has handed off. Finally, the server discards data it no longer requires.

During the hand-off process, requests related to the village or affected users may continue to arrive at the initiating server. This is decreasingly likely with time in the case of village handoff, as the target server immediately issues the BindVillageNotify message when it receives the hand-off signal. However, until such time as the initiating server drops its client connections, it is still capable of handling any requests it receives. The server may additionally forward such requests to the target server.

When a sync server is restarted, it issues a RefreshSvc transaction to a peer sync server in the cluster chosen uniformly at random by GSF. The RefreshSvc response contains all village/server bindings for the cluster, as well as the timestamp of the latest mutation. If this is the first sync server to start, the transaction is not issued (as the cluster state is evident). It is possible for updates to village bindings to be received by the newcomer in the interval when it is waiting for the response to the RefreshSvc. Such updates are cached and applied in order at the conclusion of the transaction.

The sync server is architected to optimize the handling of messages that result in information being disseminated to the relevant portion of the connected user base (e.g. player movement messages and object change notifications). In particular, data is organized to permit the control path for the execution of these “fan-out” messages to perform a minimum number of lock acquisitions and to avoid any synchronous, complex computations. To support this, many critical computations are performed by long-running, periodic background tasks (called agents), and any decisions made on the critical execution path utilize the best-available data at the time (namely, the latest values computed by the agent responsible for the calculation of the data).

Agents are intended to run frequently, in order to keep data as accurate as possible, but defer cycles to any competing real-time message processing. While the messages received by clients, user servers, and village servers are processed by the primary thread pool executing at normal priority, the background agents run on dedicated thread pools executing at very low priority.

The background agents executing on the sync server are listed below:
Agent Number of instances
Execution
Frequency
Description
SiAgent: One per n villages High (<5 sec) Computes spatial index for each user in the village, and updates user lists associated with each spatialindex as required
VisAgent: One per n villages High (<5 sec) Recomputes visibility list for each connected user in the village
FofAgent: One Low (>1 min) Recomputes friends-of-friends list for each connected user on the server

Some background agents may be extended in the future to allow the application to schedule early resumption of the agent if it encounters events that are likely to invalidate significant portions of its data.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other kinds of characters can be controlled and interacted with in similar ways.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A method, comprising:
representing a user by an avatar in a virtual world on a computer;
communicating, from the user to another user in the virtual world, where said communicating shows a picture of the user's avatar during the communicating;
said communicating including receiving entered typed text forming a message from the user, where said entered typed text are transmitted to be shown to said another user as words, characters or both words and characters;
determining if said entered typed text typed by the user includes an indication of an emotion as part of said entered typed text, said indication of said emotion being formed by text characters entered as part of said communicating and where said indication of said emotion includes characters typed as part of said message from said user and said characters do not form a word in a language of the message; and
representing said emotion represented by said characters by animating said avatar show shown as part of said communicating to show said emotion while providing said message to said another user as part of said communicating.

2. A method as in claim 1, further comprising receiving a code from a user, and providing said user with an avatar that is based on said code, wherein said code is uniquely indicative of a specific avatar in said virtual world, and said avatar is shown during said communicating.

3. A method as in claim 2, further comprising providing non-player characters in the virtual world, wherein said non-player characters are not based on codes.

4. A method as in claim 2, wherein said user is provided with both a specific avatar and a specific non-player character responsive to entering said code.

5. A method as in claim 1, wherein said indication of said emotion is text including a colon, followed by a closing parenthesis: “:)”, and wherein said representing comprises changing said avatar to represent a smile.

6. A method as in claim 1, wherein said typed text is shown within a specified bubble shape.

7. A method as in claim 6, wherein said typed text is shown in a font that represents a simulated location of the user.

8. A method as in claim 7, wherein said font represents an accent attributable to the simulated location of the user.

9. A method as in claim 1, wherein said indication of said emotion includes entered characters that include at least one punctuation mark.

10. A method as in claim 1, wherein said communicating receives information that indicates how long a user sending a message has been in a virtual location in the virtual world.
